(19) United States
(12) Patent Application Publication
(10) Pub. No.: US 2007/0089444 A1
(43) Pub. Date: Apr. 26, 2007

(54) Solar energy supplemental air-conditioner for vehicle driver

(76) Inventor: Jeffrey M. Chen, San Marino, CA (US)

Correspondence Address: Raymond Y. Chan;Suite 128, 108 N. Ynez Ave., Monterey Park, CA, 91754, US

(21) Appl. No.: 11/255,689

(22) Filed: Oct. 22, 2005

(51) Int. Cl. F25B 27/00; B60H 1/32; F28D 5/00

(52) U.S. Cl. 62/235.1; 62/314; 62/244

(57) ABSTRACT

A solar energy supplemental air-conditioner includes a solar energy collector adapted for placing on the dashboard of the vehicle to collect solar energy and a cooling fan electrically connecting to the solar energy collector, wherein the cooling fan is located within the vehicle at a position that when the cooling fan is operated, the cooling fan is adapted for generating a cooling air as a cooling effect towards a driver side of the vehicle so as to cool down an interior temperature of the vehicle at the driver side.

### BACKGROUND OF THE PRESENT INVENTION

1. Field of Invention

The present invention relates to an air cooling device, and more particularly to a solar energy supplemental air-conditioner for vehicle driver, which is powered by solar energy to generate a flow of cooling air for cooling the driver side, such as a steering wheel or a driver seat, of the vehicle.

2. Description of Related Arts

Driving in the summer time is a nuisance since the driver directly exposes under the sunlight. Therefore, most of the drivers must turn on the air conditioning in order to set an acceptable climate condition within the interior of the vehicle. However, air conditioning is not cost effective and energy efficient to cool down the interior temperature of the vehicle. Moreover, once the air conditioning is off, the hot air is trapped inside the vehicle. Especially when the driver at the time gets in the vehicle, the driver can feel the heat flowing in front of his or her face. In other words, when the driver gets in the vehicle, he or she feels like putting himself or herself in the oven.

In order to prevent the heat entering into the vehicle, the driver can tint the vehicle window to block the sunlight directly entering into the vehicle so as to prevent the interior temperature of the vehicle from rising by the heat of the sunlight. However, the tinted window of the vehicle is not allowed in some countries due to the safety purpose.

Alternatively, the driver is able to purchase a reflecting panel mounted on the windshield to block the sunlight entering into the interior of the vehicle in such a manner that before the driver leaves the vehicle, the driver can simply place the reflecting panel at an inner side of the windshield. It is a hassle for the driver to put on and take off each reflecting panel every time when the driver leaves and get in the vehicle respectively since a number of reflecting panels must be used to totally shelter all the vehicle windows. In addition, the reflecting panel can only block the sunlight directly entering into the vehicle. However, such reflecting panel cannot effectively block the radiation entering into the vehicle. Therefore, the interior temperature of the vehicle will be eventually increased.

### SUMMARY OF THE PRESENT INVENTION

A main object of the present invention is to provide a solar energy supplemental air-conditioner for vehicle driver, which is powered by solar energy to generate a flow of cooling air for cooling the driver side, such as a steering wheel or a driver seat, of the vehicle.

Another object of the present invention is to provide a solar energy supplemental air-conditioner for vehicle driver, wherein a solar energy collector is placed at the dashboard of the vehicle for collecting the solar energy such that the amount of solar energy collected by the solar energy collector is responsive to the ambient temperature.

Another object of the present invention is to provide a solar energy supplemental air-conditioner for vehicle driver, wherein a cooling fan is powered by the solar energy to generate a cooling effect at the driver side such that no powered is needed from the vehicle to save the electrical energy thereof.

Another object of the present invention is to provide a solar energy supplemental air-conditioner for vehicle driver, wherein no installation is required to connect the cooling fan to the vehicle such that the present invention is adapted to incorporate with any vehicle having the dashboard.

Another object of the present invention is to provide a solar energy supplemental air-conditioner for vehicle driver, wherein no expensive or complicated structure is required to employ in the present invention in order to achieve the above mentioned objects. Therefore, the present invention successfully provides an economic and efficient solution not only for cooling the vehicle side of the vehicle but also for operating environmental friendly so as to facilitate the practical use of the present invention.

Accordingly, in order to accomplish the above objects, the present invention provides a solar energy supplemental air-conditioner for a vehicle having a dashboard, comprising:

a solar energy collector adapted for placing on the dashboard of the vehicle to collect solar energy; and

a cooling fan electrically connecting to the solar energy collector, wherein the cooling fan is located within the vehicle at a position that when the cooling fan is operated, the cooling fan is adapted for generating a cooling air as a cooling effect towards a driver side of the vehicle so as to cool down an interior temperature of the vehicle at the driver side.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a solar energy supplemental air-conditioner for vehicle driver according to a preferred embodiment of the present invention.

FIG. 2 is an exploded perspective view of the solar energy supplemental air-conditioner for vehicle driver according to the above preferred embodiment of the present invention.

### DETAILED DESCRIPTION OF THE PREFERRED EMBODIMENT

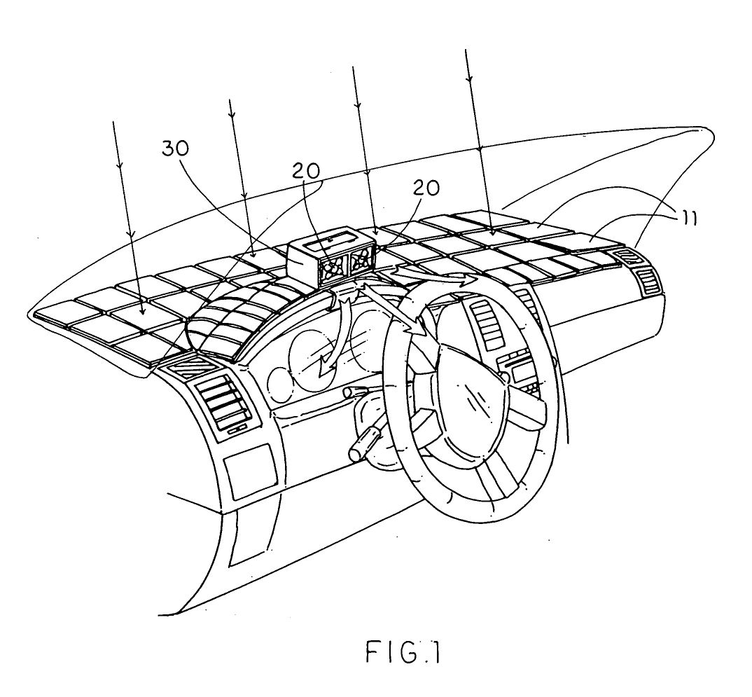

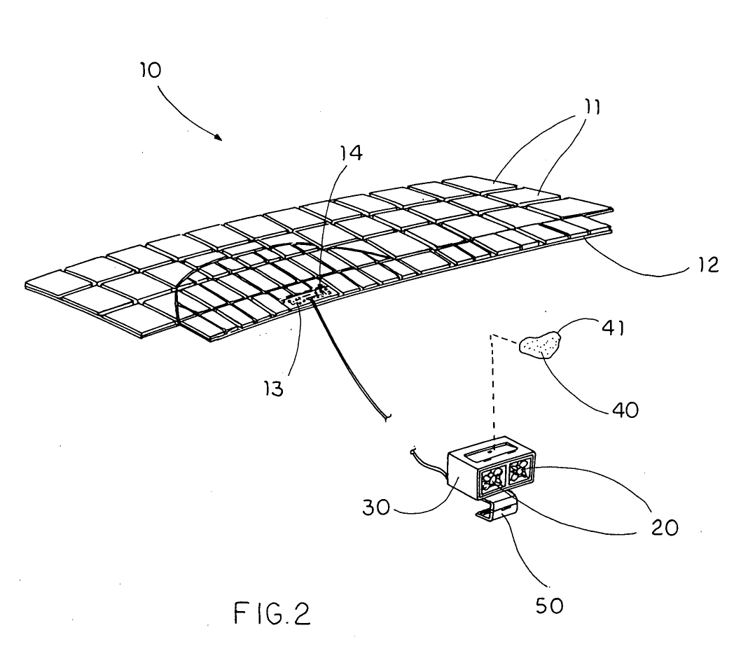

Referring to FIGS. 1 and 2 of the drawings, a solar energy supplemental air-conditioner for vehicle driver according to a preferred embodiment of the present invention is illustrated, wherein solar energy supplemental air-conditioner comprises a solar energy collector 10 and a cooling fan 20.

The solar energy collector 10 is adapted for placing on the dashboard of the vehicle to collect solar energy as a power source such that no electrical wire is required to electrically connect to the power source of the vehicle for supplying electricity.

The cooling fan 20 is electrically connecting to the solar energy collector 10 wherein the cooling fan 20 is located within the vehicle at a position that when the cooling fan 20 is operated, the cooling fan 20 is adapted for generating a cooling air as a cooling effect towards a driver side of the vehicle so as to cool down an interior temperature of the vehicle at the driver side.

According to the preferred embodiment, the solar energy collector 10 comprises a plurality of solar energy collecting panels 11 aligned side by side to form a solar energy collecting surface adapted for covering on the dashboard so as to not only collect the solar energy through a windshield of the vehicle but also to shield the dashboard. Accordingly, the dashboard has a relatively large dashboard surface that when the sunlight directly projects on the dashboard surface through the windshield, the dashboard surface will be cracked. Therefore, most drivers will purchase a dashboard protector to cover on the dashboard surface for preventing the sunlight directly projecting thereon. The solar energy collecting panels 11 function as the dashboard protector to protect the dashboard surface and collect the solar energy at the same time.

The solar energy collector 10 further comprises a foldable lining 12 having a size smaller than a size of the dashboard, wherein the solar energy collecting panels 11 are overlapped mounted on the foldable lining 12 for placing on the dashboard such that the solar energy collecting panels 11 are adapted to overlappedly fold to form a compact structure for storage. In other words, the solar energy collecting panels 11 are mounted on the foldable lining 12 side-by-side such that when the foldable lining 12 covers on the dashboard surface, the solar energy collecting panels 11 are aligned to form the solar energy collecting surface for collecting the solar energy.

The solar energy collector further comprises a converting circuit 13 and a sensor switch 14 electrically connecting between the solar energy collector 10 and the cooling fan 20. The converting circuit 13 is electrically connecting to the solar energy collecting panels 11 with the cooling fan 20 for converting the solar energy into an electrical energy. Accordingly, the more intensity of sunlight projects on the solar energy collector 10, the more amount of solar energy is collected by the solar energy collecting panels 11. In other words, during the summer time, the solar energy collecting panels 11 will collect enough solar energy to operate the cooling fan 20 so as to keep the driver side cool.

The sensor switch 14 is electrically coupled with the converting circuit 13 and is arranged to automatically actuate the cooling fan when the solar energy collector 10 collects a predetermined amount of the solar energy. The sensor switch 14 can be a thermal switch that when the solar energy collecting panels 11 collect enough solar energy which is then converted into electrical energy by the converting circuit 13, the sensor switch 14 is automatically activated to switch on the cooling fan 20.

As shown in FIG. 2, the solar energy supplemental air-conditioner further comprises a fan housing 30 supporting the cooling fan 10 and a cooling agent 40 received in the fan housing 30 for enhancing the cooling effect of the cooling air towards the driver side of the vehicle. Accordingly, the cooling agent 40, having water absorbing ability, disposed in a construction pocket 41 for absorbing and retaining water therein and releasing the water by evaporation so as to provide a cooling effect for the cooling air.

The cooling agent 40, according to the preferred embodiment, is made of resin wherein the cooling agent 40 is capable of absorbing a relatively large amount of water. After absorbing the water, the cooling agent 40 expends its size in order to keep the amount of water therein. Even though a pressure is applied on the cooling agent 40, the water will not be released from the cooling agent 40. In other words, after the cooling agent 40 absorbs the water, the construction pocket 41 is still remained in a dry condition.

Before the cooling agent 40 absorbs the water, the cooling agent 40 is in a solid phase, preferred in a granular shaped. However, after soaking with the water, the cooling agent 40 expands its size and changes its phase from solid from liquid such as gel form. It is worth to mention that the construction pocket 41 is shaped and sized to fit the cooling agent 40 after water absorption so as to retain the gel form cooling agent 40 in the construction pocket 41. Moreover, only water is capable of permeating through the construction pocket 41, the cooling agent 40 will be kept in the construction pocket 41 without leaking therefrom.

Accordingly, the driver is able to soak the construction pocket 41 with water, preferred ice water. Then, the water will permeate into the construction pocket 41 wherein the cooling agent 40 will absorb the water and change the phase from solid to liquid. Therefore, the driver is able to place the construction pocket 41 into the fan housing 30 for providing a cooling effect for the cooling air.

In order to hold the cooling fan 20 in position, the solar energy supplemental air-conditioner further comprises a detachable stand 50 supporting the cooling fan 20 thereon for detachably mounting on the dashboard to align the cooling fan 20 towards the driver side of the vehicle. As shown in FIG. 2, the detachable stand 50 is downwardly extended from the fan housing 30 to support the cooling fan 20. The detachable stand 50 comprises a detachable clip adapted to detachably clip at an edge of the dashboard to retain the cooling fan 20 in position. As shown in FIG. 1, the cooling fan 20 is mounted on the dashboard to align with the steering wheel such that the cooling fan 20 is adapted to generate the cooling air towards the steering wheel so as to cool down the steering wheel. In addition, the cooling air also flows towards the driver seat to keep the driver seat cool at the same time.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A solar energy supplemental air-conditioner for a vehicle having a dashboard, comprising:
a solar energy collector adapted for placing on said dashboard of said vehicle to collect solar energy; and
a cooling fan electrically connecting to said solar energy collector, wherein said cooling fan is located within said vehicle at a position that when said cooling fan is operated, said cooling fan is adapted for generating a cooling air as a cooling effect towards a driver side of said vehicle so as to cool down an interior temperature of said vehicle at said driver side.

2. The solar energy supplemental air-conditioner, as recited in claim 1, wherein said solar energy collector comprises a plurality of solar energy collecting panels aligned side by side to form a solar energy collecting surface adapted for covering on said dashboard so as to not only collect said solar energy through a windshield of said vehicle but also to shield said dashboard.

3. The solar energy supplemental air conditioner, as recited in claim 2, wherein said solar energy collector further comprises a foldable lining having a size smaller than a size of said dashboard, wherein said solar energy collecting panels are overlapped mounted on said foldable lining for placing on said dashboard such that said solar energy collecting panels are adapted to overlappedly fold to form a compact structure for storage.

4. The solar energy supplemental air-conditioner, as recited in claim 2, wherein said solar energy collector further comprises a converting circuit electrically connecting to said solar energy collecting panels with said cooling fan for converting said solar energy into an electrical energy.

5. The solar energy supplemental air-conditioner, as recited in claim 3, wherein said solar energy collector further comprises a converting circuit electrically connecting to said solar energy collecting panels with said cooling fan for converting said solar energy into an electrical energy.

6. The solar energy supplemental air-conditioner, as recited in claim 1, further comprising a sensor switch which is electrically connecting between said solar energy collector and said cooling fan and is arranged to automatically actuate said cooling fan when said solar energy collector collects a predetermined amount of said solar energy.

7. The solar energy supplemental air-conditioner, as recited in claim 2, further comprising a sensor switch which is electrically connecting between said solar energy collector and said cooling fan and is arranged to automatically actuate said cooling fan when said solar energy collector collects a predetermined amount of said solar energy.

8. The solar energy supplemental air-conditioner, as recited in claim 5, further comprising a sensor switch which is electrically connecting between said solar energy collector and said cooling fan and is arranged to automatically actuate said cooling fan when said solar energy collector collects a predetermined amount of said solar energy.

9. The solar energy supplemental air-conditioner, as recited in claim 1, further comprising a fan housing supporting said cooling fan and a cooling agent received in said fan housing for enhancing said cooling effect of said cooling air towards said driver side of said vehicle.

10. The solar energy supplemental air-conditioner, as recited in claim 5, further comprising a fan housing supporting said cooling fan and a cooling agent received in said fan housing for enhancing said cooling effect of said cooling air towards said driver side of said vehicle.

11. The solar energy supplemental air-conditioner, as recited in claim 8, further comprising a fan housing supporting said cooling fan and a cooling agent received in said fan housing for enhancing said cooling effect of said cooling air towards said driver side of said vehicle.

12. The solar energy supplemental air-conditioner, as recited in claim 9, wherein said cooling agent, having water absorbing ability, disposed in a construction pocket for absorbing and retaining water therein and releasing said water by evaporation so as to provide a cooling effect for said cooling air.

13. The solar energy supplemental air-conditioner, as recited in claim 10, wherein said cooling agent, having water absorbing ability, disposed in a construction pocket for absorbing and retaining water therein and releasing said water by evaporation so as to provide a cooling effect for said cooling air.

14. The solar energy supplemental air-conditioner, as recited in claim 11, wherein said cooling agent, having water absorbing ability, disposed in a construction pocket for absorbing and retaining water therein and releasing said water by evaporation so as to provide a cooling effect for said cooling air.

15. The solar energy supplemental air-conditioner, as recited in claim 12, wherein said cooling agent is a solid resin disposed in said construction pocket in such a manner that when said cooling agent is soaked with water, said water is absorbed by said cooling agent to expand a size thereof and change a phase from solid to liquid, and when said interior temperature is increased, said cooling agent starts to exchange a heat energy to evaporate said water in said cooling agent.

16. The solar energy supplemental air-conditioner, as recited in claim 13, wherein said cooling agent is a solid resin disposed in said construction pocket in such a manner that when said cooling agent is soaked with water, said water is absorbed by said cooling agent to expand a size thereof and change a phase from solid to liquid, and when said interior temperature is increased, said cooling agent starts to exchange a heat energy to evaporate said water in said cooling agent.

17. The solar energy supplemental air-conditioner, as recited in claim 14, wherein said cooling agent is a solid resin disposed in said construction pocket in such a manner that when said cooling agent is soaked with water, said water is absorbed by said cooling agent to expand a size thereof and change a phase from solid to liquid, and when said interior temperature is increased, said cooling agent starts to exchange a heat energy to evaporate said water in said cooling agent.

18. The solar energy supplemental air-conditioner, as recited in claim 8, further comprising a detachable stand supporting said cooling fan thereon for detachably mounting on said dashboard to align said cooling fan towards said driver side of said vehicle.

19. The solar energy supplemental air-conditioner, as recited in claim 11, further comprising a detachable stand supporting said cooling fan thereon for detachably mounting on said dashboard to align said cooling fan towards said driver side of said vehicle.

20. The solar energy supplemental air-conditioner, as recited in claim 17, further comprising a detachable stand supporting said cooling fan thereon for detachably mounting on said dashboard to align said cooling fan towards said driver side of said vehicle.
